(19) United States
(12) Patent Application Publication
(10) Pub. No.: US 2014/0214187 A1
(43) Pub. Date: Jul. 31, 2014

(54) RC/Autonomous Machine Mode Indication

(71) Applicant: CATERPILLAR INC., Peoria, IL (US)

(72) Inventors: Seth J. Redenbo, Metamora, IL (US); Brian G. Funke, Peoria, IL (US)

(73) Assignee: CATERPILLAR INC., Peoria, IL (US)

(21) Appl. No.: 13/755,810

(22) Filed: Jan. 31, 2013

(51) Int. Cl. G05B 19/04

(52) U.S. Cl. CPC G05B 19/04
USPC 700/83

(57) ABSTRACT

A method and system for displaying machine mode information to a remote operator of a plurality of machines includes collecting video data from each of the machines, collecting machine sensor information from each of the machines, collecting machine alert information with respect to each of the machines, and collecting machine operating mode data with respect to each of the machines. A machine display is then provided at a remote control center including one or more screen regions corresponding to the video of one or more machines. The machine display further includes a machine mode and alert indicator including machine areas associated with each of the machines, wherein each machine area including a graphical mode indicator denoting an operating mode of the associated machine.

### TECHNICAL FIELD OF THE DISCLOSURE

The present disclosure relates to remote and autonomous control of earth-moving machines and, more particularly, relates to a system and method for conveying machine mode information to a remote operator.

### BACKGROUND OF THE DISCLOSURE

Many industrial activities require the use of earth moving machines, material lifting and handling machines, and other large machines. In order to improve operator safety and productivity while reducing operator fatigue, the operation of such machines is increasingly automated and/or executed via remote control (RC). In this way, an operator may monitor and control a machine from the safety and quiet of a remote control center rather than spending the work day in the cab of the machine itself.

However, it is difficult when using such systems, for an operator to maintain an awareness of the status of multiple remote machines. For example, while the operator is concentrating on the status or operation of one machine, another machine may be experiencing an operational or situational problem that requires operator intervention.

In order to increase operator awareness, certain systems have been developed that attempt to associate more machine data with icons representing various machines. For example, U.S. Patent Application 20040039527A1 describes a system that provides status information regarding the location and state of multiple vehicles. The system utilizes an onboard receiver and a vehicle condition sensor to generate status information that is sent to a main database. The database is accessed by a central dispatch center, and the data records are utilized to provide visual indicators to a dispatcher regarding the vehicles. In particular, the operator display shows each vehicle located on a map, and a vehicle identification and state is identified next to each icon.

However, within a system such as that described in the '527 application, it is a time consuming task to ascertain the state of the entire fleet; the operator is required to sequentially focus on each vehicle icon to gather information about that vehicle. As such, while some progress has been made in identifying machine locations and states in a multiple-machine environment, there is still a need to enhance operator situational awareness during the use of real-time video monitoring in a manner that does not lead to excess attention capture.

The present disclosure is directed at least in part to a system that may address this need. However, it should be appreciated that the solution of any particular problem is not a limitation on the scope of this disclosure nor of the attached claims except to the extent expressly noted. Additionally, the inclusion of material in this Background section is not an indication that the material represents known prior art other than material associated with a patent number, publication number or other indicia of publication. With respect to any such identified prior art, the foregoing characterization is not itself prior art but is simply a brief summary for the sake of reader convenience. The interested reader is referred to the identified documents themselves for a more accurate understanding.

### SUMMARY OF THE DISCLOSURE

In accordance with one aspect of the present disclosure, a method is provided for displaying machine mode information to a remote operator of a plurality of machines. In accordance with this aspect, the method entails collecting video data from each of the machines, collecting machine sensor information from each of the machines, generating machine alert information with respect to each of the machines, and collecting machine operating mode data with respect to each of the machines. A machine display is then provided at a remote control center, the machine display including a machine mode and alert indicator including machine areas associated with the machines, wherein each machine area including a graphical mode indicator denoting an operating mode of the associated machine.

In accordance with another aspect of the present disclosure, a method is provided for displaying machine mode information to a remote operator of a plurality of machines. The method includes displaying video data gathered from at least one of the machines via a video display screen, and displaying a machine mode and alert indicator as well. The machine mode and alert indicator includes multiple machine areas, each being associated with one of the machines. Each machine area includes a graphical mode indicator visually denoting the operating mode of the associated machine.

In accordance with yet another aspect of the present disclosure, a system is provided for displaying an operating mode for each of a plurality of machines to an operator situated at a remote control center. In accordance with this aspect, the system includes a wireless link configured to wirelessly gather data from each of the plurality of machines. The system also includes a processor configured to generate the operating mode for each of the machines based on the gathered data and generate a display with a machine mode and alert indicator having a plurality of adjacent machine areas. Each machine area is associated with one of the machines, and each machine area includes a graphical mode indicator visually denoting the operating mode of the associated machine.

Other features and advantages of the disclosed systems and principles will become apparent from reading the following detailed disclosure in conjunction with the included drawing figures.

### BRIEF DESCRIPTION OF THE DRAWINGS

FIG. 1 is a schematic diagram of an RC/autonomous machine control and monitoring architecture in accordance with an aspect of the disclosure;

FIG. 2 is a schematic diagram of a machine data and control system in accordance with an aspect of the disclosure;

FIG. 3 is a schematic diagram of a remote control center architecture in accordance with an aspect of the disclosure;

FIG. 4 is a schematic diagram of an example display in accordance with an aspect of the disclosure;

FIG. 5 is a detailed schematic diagram of a machine mode and alert indicator in accordance with an aspect of the disclosure; and

FIG. 6 is a flow chart illustrating a process of machine data presentation and control in accordance with an aspect of the disclosure.

### DETAILED DESCRIPTION OF THE DISCLOSURE

The present disclosure provides a system and method applicable to earth-moving machines and other industrial machines used in remote control/autonomous control applications such as in mining applications wherein it is desired to provide a remote operator with video information as well as machine mode and alert information. The system and method further provide a remote operator with visual machine alert and operating mode indicators to ease the operator's burden of operating and monitoring multiple machines. In an embodiment, some or all alert and operating mode indicators may be selectable to view related alert information in greater detail or to alter the operating mode of one or machines. Alerts may be of different urgency levels, and the various levels may be displayed by one or more visual distinctions and/or via an audible alert tone.

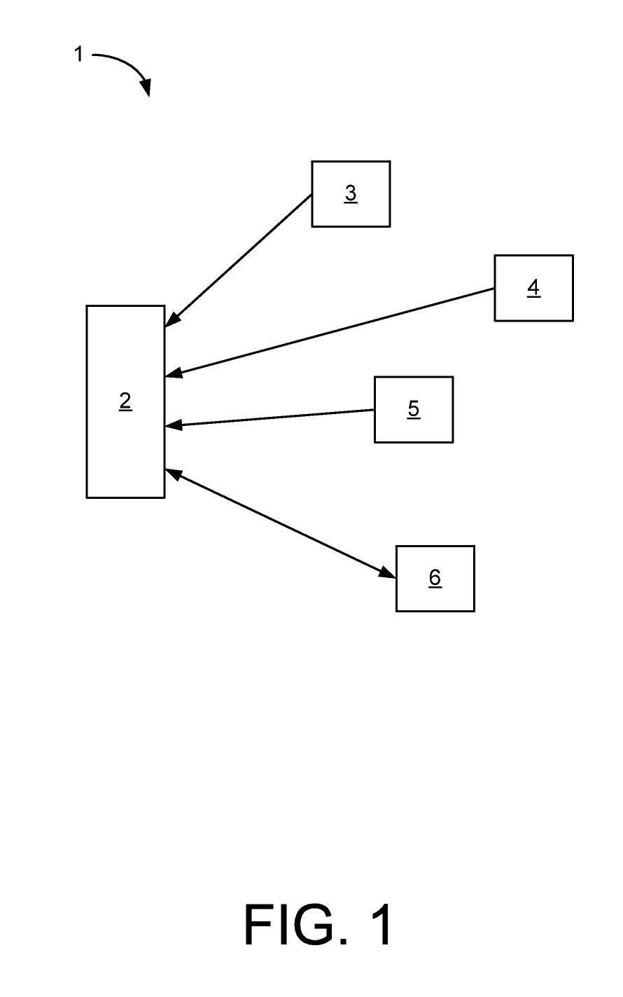

Having given the above overview and referring now more specifically to the drawing figures, FIG. 1 is a schematic diagram of a machine control and monitoring system 1 in accordance with an implementation of the disclosed principles. The illustrated control and monitoring system 1 includes a remote control center 2, which is a location at which a human operator may control and/or monitor multiple remote machines. The machines in the illustrated example include a first machine 3, a second machine 4, a third machine 5, and a fourth machine 6.

As will be discussed in detail hereinafter, the remote control center 2 includes facilities to allow the operator to view, via video, the operation of one or more of the multiple machines, as well as to select machines for control or monitoring and to respond to any machine alerts. The communication between the remote control center 2 and the multiple machines 3, 4, 5, 6 may be unidirectional or bidirectional. For example, when a machine is being remotely controlled by the operator, the communications from the remote control center 2 to the machine in question may contain control information, and returning communications may contain status and video information. For machines not currently being controlled, but instead operating autonomously, the machine may provide status and video information to the remote control center 2 without receiving control commands.

In an embodiment, the communications between the remote control center 2 and a machine are wireless, and may be direct, as in the case of short range wireless communications technology, or may be indirect, as in the case of cellular or other long range communications technologies. In addition, all or some such communications may be encrypted or encoded for security purposes. For example, encryption of remote control commands may prevent unauthorized third parties from controlling a machine in a dangerous or damaging manner.

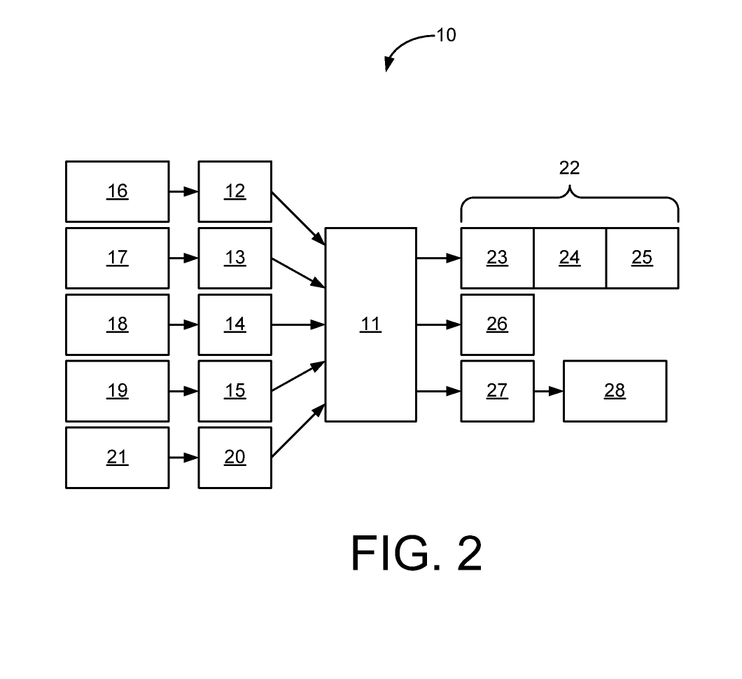

It will be appreciated that in an implementation of the described architecture, the remote control center 2 is adapted for control and monitoring of the various machines 3, 4, 5, 6, while the various machines 3, 4, 5, 6 are configured to communicate with and receive control data from the remote control center 2. FIG. 2 is a schematic diagram of a machine data and control system in accordance with an implementation of the disclosed principles. The illustrated machine data and control system 10 includes a controller 11 in communication with multiple inputs and outputs to be described. The controller 11 may be any device that controls the receipt and processing of data obtained from the various inputs while also generating commands and/or data for provision to the various outputs.

The controller 11 may be based on integrated circuitry, discrete components, or a combination of the two. In an embodiment, the controller 11 is implemented via a computerized device such as a PC, laptop computer, or integrated machine computer which may be configured to serve the functions of controller 11 as well as numerous other machine functions. In an alternative embodiment, the controller 11 is a dedicated module. In such a case, the controller 11 may be a PLA, processor-based device or collection of devices.

Regardless of how it is implemented, the controller 11 operates, in an embodiment, by executing computer-executable instructions read from a nontransitory computer-readable medium such as a read only memory, a random access memory, a flash memory, a magnetic disc drive, an optical disc drive, and the like. Similarly, the data processed by the controller 11 may be read from memory in addition to being obtained from one or more of the various machine inputs. The memory may reside on the same integrated circuit device as the processor of the controller 11 or may be alternatively or additionally located separately from the controller 11.

While the controller 11 and its various inputs and outputs will be described by way of a spoke and hub architecture, it will be appreciated that any suitable bus type may be used. For example, inputs and outputs may be serially multiplexed by time or frequency rather than being provided over separate connections. Similarly, peer-to-peer communications may be used instead of or in addition to direct communications. It will be appreciated that peripheral circuitry such as buffers, latches, switches and so on may be implemented within the controller 11 or separately as desired. Because those of skill in the art will appreciate the usage of such devices, they will not be further described herein.

As noted above, the controller 11 receives a number of inputs or input signals. In the illustrated embodiment, the controller 11 is shown receiving a GPS input 12, a pitch input 13, a roll input 14, and a camera data input 15. The GPS input 12 may provide location data containing an indication of a current location of the machine. Such data may be derived from a GPS module 16. It will be appreciated that the GPS module 16 may be integrated with the control or data systems of the machine or may be a separate unit.

The pitch input 13 provides data containing an indication of the current pitch angle of the machine. Pitch angle typically references the angle between a level surface and the machine axis in the direction of travel. By way of example, the data containing the indication of the current pitch angle may be derived from a pitch sensor module 17. The pitch sensor module, which may be integrated with the machine data or control systems or may be a separate module, may measure the pitch of the tracks or other undercarriage of the machine or may measure the pitch of the machine cab. Pitch may be measured via a gravitational sensor or other internal or external means for detecting an amount of divergence from a level attitude.

Similar to the pitch input 13, the roll input 14 provides data indicative of a degree of roll of the machine (roll angle). The roll angle typically measures the angle between a level surface and the machine axis perpendicular to the direction of travel, and may be obtained from or derived by a roll sensor module 18. The roll sensor module 18, which may be an integrated or separate component in the same manner as the pitch sensor module 17, may measure the roll angle of the undercarriage or of the cab depending upon the implementation desired. Measurement of the roll angle may be made via a gravitational sensor or other internal or external means as noted above with respect to the measurement of the pitch angle.

As noted above, the inputs to the controller 11 may also include a camera data input 15. The camera data input receives data from one or more onboard cameras 19. The one or more onboard cameras 19 are digital video cameras in an embodiment, and may be situated to show portions of the machine and/or surrounding terrain. For example, a camera may be directed forward to capture video of the terrain toward which the machine is travelling as well as the position of a forward-placed implement or tool, such as a blade. The one or more onboard cameras 19 may also include a rearward-facing camera to capture video of the terrain, objects, and/or personnel that the machine may travel towards if operated in reverse.

Finally, the controller 11 also receives a radio input 20 in an embodiment. The radio input 20 provides the controller 11 with control signals received by an onboard radio receiver 21. The control signals may be received from a remote transmitter operated autonomously or by a human operator, and may provide control instructions to one or more machine systems or functions such as acceleration, deceleration, steering, tool placement and angle, and so on. The onboard radio receiver 21 may be integrated with the machine data and control systems or may be a separate module.

As noted above, the controller 11 also provides a number of outputs in an embodiment. For example, the controller 11 may provide a radio command output 22 to convey control commands to various machine systems or functions. In an embodiment, the control commands conveyed by the radio command output 22 include an acceleration/deceleration command output 23, a steering command output 24, and a tool position/attitude command output 25.

The acceleration/deceleration command output 23 may be configured and routed to control the machine transmission, brakes, and engine, electric propulsion motor(s) and/or hydraulic propulsion motor(s). The steering command output 24 may be configured and routed to control the direction of travel of the machine. The mechanism for directional control will be related to the machine type, but example steering mechanisms include wheel steering, frame articulation, differential track movement, and so on. The tool position/attitude command output 25 provides tool control commands to manipulate a tool or implement mounted on the machine. In the case of a machine having a blade, e.g., a dozer, the tool control commands may include commands to set the blade height, blade tilt and blade roll for example.

The controller 11 also provides a camera control command output 26 in an embodiment. The control command output 26 includes camera command signals to set the position or function of one or more cameras mounted on the machine. As noted above, such cameras may include a forward directed video camera and/or a rearward directed video camera.

Finally, the controller also provides a wireless link output 27. The wireless link output conveys machine operation data and camera data to a transmitter module 28. The transmitter module 28 is configured in an embodiment to wirelessly convey the received data to a remote receiver, e.g., at a remote operator station.

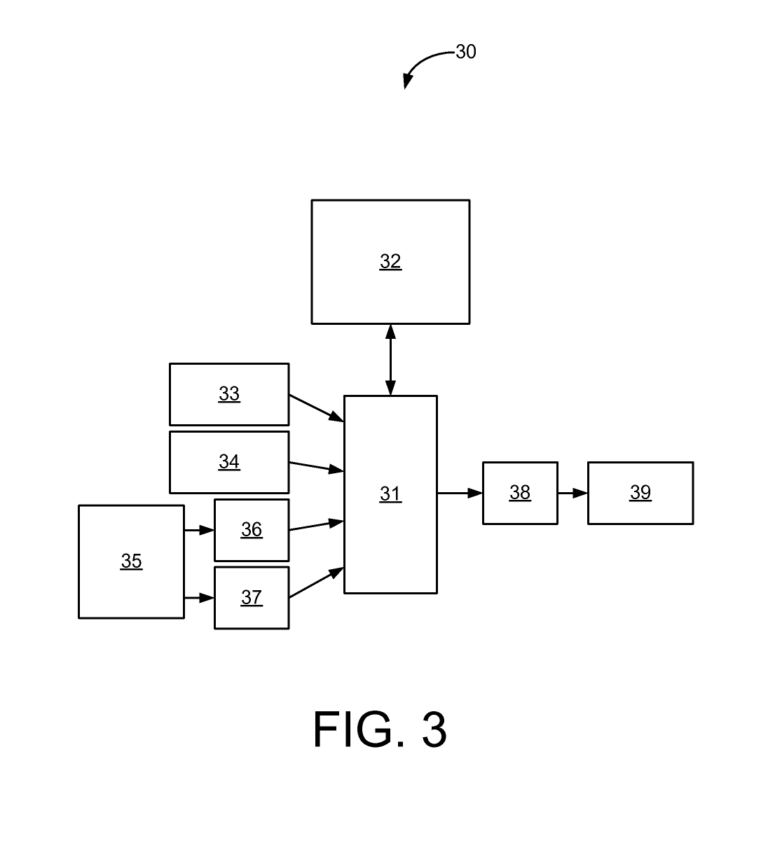

As noted above, the controller 11 is in communication, via certain inputs and outputs, with a remote control center in an embodiment. The schematic diagram of FIG. 3 illustrates a remote control center system implementation that may be used in conjunction with the system illustrated in FIG. 2. The remote control center architecture 30 includes a computing device 31, which may be a personal computer, laptop computer, computing console, or other computing device.

The computing device 31 is configured to receive a number of inputs and to provide a number of outputs. In an embodiment, the computing device 31 is linked to display screen 32. The display screen 32 may be separate from or integrated with the computing device 31. While the display screen 32 is configured to display material to a user or operator of the computing device 31, the display screen may also act as an input device, receiving user input via a touch screen mechanism for example.

In addition to the display screen 32, operator inputs may also be received via a keyboard input device 33 connected to the computing device 31. As with the display screen 32, the keyboard input device 33 may be an external device or may be integrated with the computing device 31. Further user input to the computing device 31 may be provided via one or more peripheral user interface devices such as a joystick 34 or other input device.

The computing device 31 is further configured and connected to receive signals from a radio receiver 35. In particular, in an embodiment, the computing device 31 receives a video data input 36, corresponding to remotely transmitted video information, and a machine data input 37, corresponding to remotely transmitted machine data, from the radio receiver 35. The remotely transmitted video information and machine data may originate from a machine data and control system 10 as described above with respect to FIG. 2.

To facilitate communications back to the machine data and control system 9, the computing device 31 is further configured and connected to provide a remote control output 38 to an operator station transmitter 39. The operator station transmitter 39 is configured to communicate with the onboard radio receiver 21 of the remote machine data and control system 10. In particular, the range and frequency of transmission are such as to be received and decoded by the onboard radio receiver 21.

During remote RC and/or autonomous operation of one or more machines equipped as discussed above with respect to FIG. 2, the display screen 32 is driven by the controller 11 so as to show the live video data received from one or more cameras located on one or more remote machines as well as a graphical overlay reflecting various machine operating states and alerts. In an embodiment, the graphical overlay comprises a plurality of graphical indicators located together in a region of the display. Each graphical indicator comprises an image, rather than a purely textual presentation, that conveys information regarding machine operation and status.

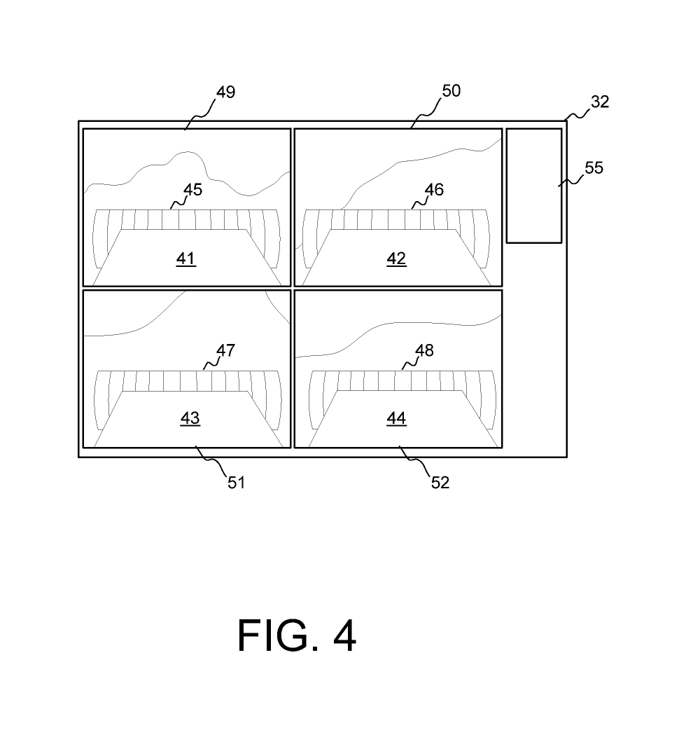

An example display in accordance with this embodiment is shown schematically in FIG. 4. In the illustrated example, the display screen 32 presents a video display 40 including video material corresponding to video data captured by forward-facing cameras mounted on each remote machine. The video material includes, in the illustrated embodiment, video of a portion of the associated earthmoving machine itself as well as the surrounding terrain, structures, objects and/or personnel. To simplify the drawing figure, only the machine front portion 41, 42, 43, 44 and machine blade 45, 46, 47, 48 are shown. In the illustrated embodiment, the video for each machine is shown in a separate screen region 49, 50, 51, 52.

In accordance with one aspect of the disclosure, a machine mode and alert indicator 55 is overlaid on or presented next to the screen regions 49, 50, 51, 52 wherein machine video data is displayed. The machine mode and alert indicator 55 is used to convey machine identity, machine health status, wireless link status, and machine operating mode. In an embodiment, the machine mode and alert indicator 55 is further operative to present one or more selectable elements allowing the operator to change the operating mode of the machines. In a further embodiment, the machine mode and alert indicator 55 presents one or more selectable elements allowing the operator to obtain further information regarding the health of one or more of the machines.

It will be appreciated that the manner of displaying video is not critical and that various other display modes may be employed. For example, in accordance with another aspect of the disclosure, the video display 40 includes one or more screen regions that correspond to video captured at a single machine, e.g., a machine currently being remotely controlled by the operator. In this embodiment, the operator may toggle the displayed video from that of one machine to that of another by selecting an appropriate area in the machine mode and alert indicator 55. Alternatively, another selectable element on the video display 40 or elsewhere may serve this role.

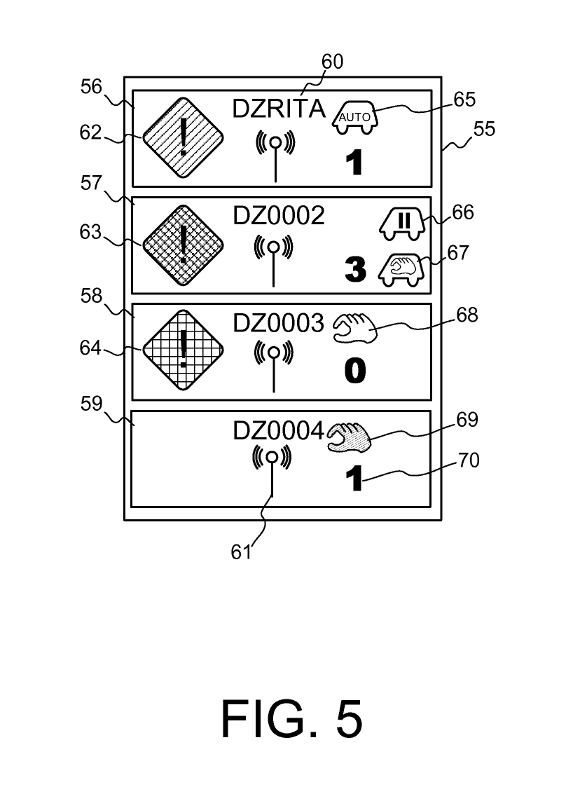

The machine mode and alert indicator 55 is shown in greater detail in the schematic diagram of FIG. 5. In the illustrated example, the machine mode and alert indicator 55 contains several individual machine areas including a first machine area 56, a second machine area 57, a third machine area 58 and a fourth machine area 59. It will be appreciated that the number of machine areas 56, 57, 58, 59 will depend upon the number of machines being monitored by the operator. In the illustrated example, four machines are being monitored, but in the event that a greater or lesser number of machines are monitored, a correspondingly greater or lesser number of machine areas may be displayed.

Each machine area 56, 57, 58, 59 in the illustrated example includes a number of fields, some of which are static, some of which are dynamic, and some of which may be selectable to obtain information or alter the machine operating mode. In particular, each machine area 56, 57, 58, 59 contains a machine name field 60 which conveys a name of the associated machine. The machine names may be transmitted from the machines themselves or from another location. Alternatively, the machine names may be entered by the operator or other personnel.

Further, each machine area 56, 57, 58, 59 in the illustrated example contains a wireless link indicator 61. In an embodiment, the wireless link indicator 61 is usable to indicate the status of a wireless link between the remote control center and each machine. In the illustrated embodiment, each wireless link indicator indicates that the associated wireless link is active, meaning that control commands, data, video, etc. may be wirelessly exchanged between the remote control center and the machines.

As noted above, the machine mode and alert indicator 55 is also operable to display a health level indicator for each machine when an alert is active for that machine. In the illustrated example, machine area 56, machine area 57 and machine area 58 display, respectively, a first health level indicator 62, a second health level indicator 63, and a third health level indicator 64.

The appearance of each health level indicator is adapted to convey a level of urgency of the associated alert. For example, the first health level indicator 62 is displayed with a first color or pattern (indicated in the figure by a first hash type). In a colored implementation, the first health level indicator 62 may be white for example. The first color or pattern indicates a first health level with respect to the health of the machine associated with the first machine area 56. By way of example, the first health level may indicate that the machine is experiencing a problem, but that the severity of the problem is such that it need not be addressed until the next scheduled service. Problems of this type may include, for example, a slow loss of operating or lubricating fluid, a slightly high temperature in a monitored component, low but usable system pressure, etc.

Other health levels may indicate problems of increasing severity. For example, the second health level indicator 63 is displayed with a second color or pattern (indicated in the figure by a second hash type). In a colored implementation, the second health level indicator 63 may be yellow for example. The second color or pattern indicates a second health level with respect to the health of the machine associated with the second machine area 57. By way of example, the second health level may indicate that the machine is experiencing a problem, and that the severity of the problem is such that the machine should be scheduled for service to address the problem. Problems of this type may be problems that increase control difficulty, reduce job productivity or quality, and/or cause accelerated wear to one or more machine components. Such problems may include, for example, a slipping drive element, a steering imbalance, loss of a redundant sensor, etc.

In the illustrated example, a third health level indicator 64 is displayed with a third color or pattern (indicated in the figure by a third hash type). In a colored implementation, the third health level indicator 64 may be red for example. The third color or pattern indicates a third health level with respect to the health of the machine associated with the third machine area 58. By way of example, the third health level may indicate that the machine is experiencing a problem, and that the severity of the problem is such that the machine should be taken offline and immediately serviced to address the problem. Problems of this type may be problems that prevent the machine from performing its task or that present a danger of immediate severe damage to the machine or the site. Such problems may include, for example, loss of all sensors associated with a critical parameter, loss of communications capabilities, severe engine or motor overheating, loss of a critical capability such as steering or braking, etc.

As noted above, each health alert level may be visually conveyed via the use of a distinctive color and/or pattern. In addition or alternatively, the health alert levels may be conveyed via blinking or other dynamic modification of the associated health level indicator. For example, the most urgent alert (shown in the example via third health level indicator 64 associated with machine area 58) may be configured to blink on and off or to blink from one color to another so as to draw the operator's attention.

Similarly, the existence of an important alert, i.e., any alert or an alert of greater than a certain urgency level, may be signaled to the operator via an audible signal. For example, an alert of the first level may be signaled with a first health level indicator 62 as discussed above, an alert of the second level may be signaled with a second health level indicator 63 as well as an intermittent audible tone, and an alert of the third level may be signaled with a third health level indicator 64 as well as a tone that is louder and/or more persistent than the tone used to signal the second alert level. Alternatively, an audible tone may be used for all alerts, or only to signal a third level alert or a subset of third level alerts.

In an alternative embodiment, an audible tone is used in addition to a dynamic visual variation at some or all alert levels. Thus, for example, an alert regarding the third health level may be signaled by a persistent tone as discussed above in addition to a flashing or periodic color change in the third health level indicator 64.

In addition to the health level indicators, each machine area 56, 57, 58, 59 may also contain one or more elements to signal and potentially affect an operating mode of the associated machine. Thus, for example, in the illustrated example, the first machine area 56 contains a graphical first mode indicator 65 conveying the operating mode of the associated machine. In the configuration shown, the first mode indicator 65 indicates that the associated machine is in an autonomous mode, meaning for example that the associated machine is controlling itself, or being controlled by another entity, without operator intervention.

In the illustrated example, the second machine area 57 contains a graphical second mode indicator 66 conveying the operating mode of the associated machine. In the configuration shown, the second mode indicator 66 indicates that the associated machine has been in an autonomous operating mode, but that the machine operation has been paused. The pause may have been automatically invoked due to the existence of an alert, due to encountering a condition that requires operator input such as a rock or other obstruction in the slot, or due to expiration of a time period or number of passes after which operator input is required. In the illustrated configuration, the second mode indicator 66, like the first mode indicator 65, is shaped generally like a vehicle although any other shape may be used for any or all of the mode indicators.

In addition to the second mode indicator 66, the second machine area 57 as illustrated further contains a graphical connection element 67 selectable by the operator to commence remote control of the associated machine. Thus, for example, if the operator selects the connection element 67, the second mode indicator 66 may be removed and the connection element 67 may be changed into an element that signals ongoing remote control. Such an element will be discussed below.

In the illustrated example, the third machine area 58 is shown containing a third mode indicator 68 that signals that the associated machine is in a remote control (RC) operating mode. When a machine is in the RC operating mode, the operator is able to control the machine remotely. In an embodiment, selection of the RC mode for any machine will cause any other machine that is in the RC operating mode to revert to an autonomous operating mode or a paused operating mode wherein the RC operating mode is signaled as being inactive.

In the illustrated embodiment, the fourth machine area 59 is shown containing a fourth mode indicator 69 that signals that the associated machine has been in a RC operating mode, but that the RC mode is now inactive. Like the third mode indicator 68 that signals that the associated machine is in the RC operating mode, the fourth mode indicator 69 is shaped as a hand. However, any graphical symbol may be used for either the third mode indicator 68 or the fourth mode indicator 69, and the same symbol need not be used for both. In the illustrated embodiment, the fourth mode indicator 69 is distinguished from the third mode indicator 68 by the use of distinct hashing, although any other distinction such as color, size, shape, etc. may be used to distinguish the two.

Further, each machine area 56, 57, 58, 59 in the illustrated example contains a passes remaining indicator 70. In an embodiment, the passes remaining indicator 70 identifies how many passes of the slot or other path remain to be executed. In the interface shown, the passes remaining indicator 70 in machine area 56 indicates that one pass remains, while three, zero, and one pass respectively remain in machine area 57, machine area 58 and machine area 59.

Although the illustrated example shows the simultaneous use of operating mode indicators as well as selectable mode changing elements, it will be appreciated that these elements may not necessarily appear simultaneously depending upon the machine states. In an alternative embodiment, only the operating mode indicators are used within the several machine areas 56, 57, 58, 59, with machine mode changes being made available, if at all, through a separate interface. For example, machine mode changes may be facilitated through selectable icons within the separate screen regions 49, 50, 51, 52.

In an embodiment, when a machine is not in an active autonomous operation mode or an active RC operation mode, the machine is placed in a safe state to await further action. For example, any machine transitioning to autonomous paused mode or an RC paused mode may be placed in a parked state and may have an implement lockout applied. Alternatively, the safe state may entail other or different precautions. For example, the machine engine or other power source may powered off and the hydraulic system may be depressurized.

### INDUSTRIAL APPLICABILITY

In general terms, the present disclosure sets forth a system and method applicable to earth-moving machines and other industrial machines used in remote control/autonomous control applications such as in mining applications wherein it is desired to provide a remote operator with video information as well as machine mode and alert information. The machines to which the operator interfaces via the disclosed system may be of the same or different machine types. In an embodiment, each machine is a dozer, and each dozer is being utilized in a mining operation. However, the system may be used in other applications and/or with different machines. Although the system is well-suited to the execution of repetitive tasks, the specific application wherein the system is used need not involve such tasks.

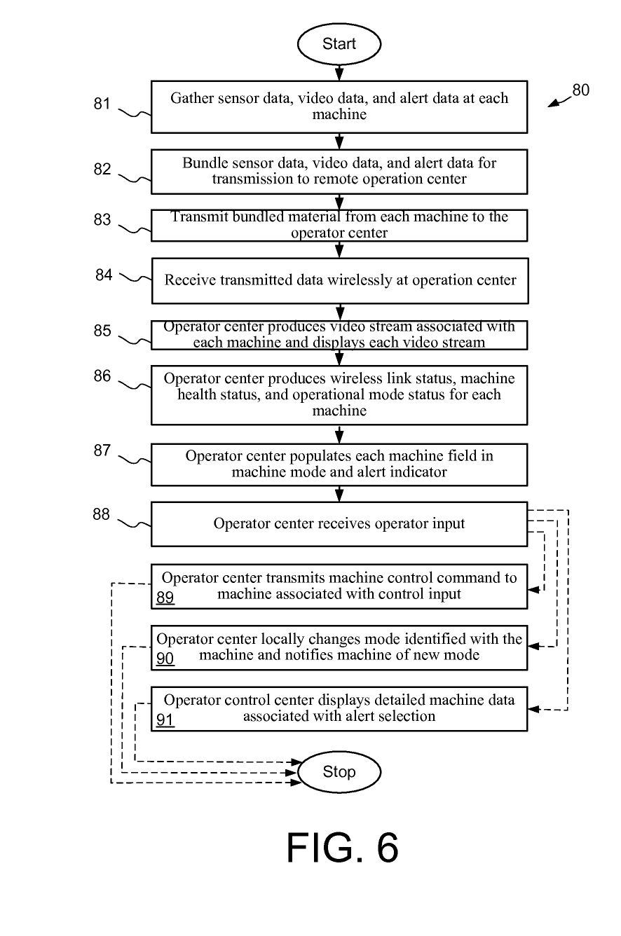

While those of skill in the art will appreciate that there are numerous alternative ways in which to implement the described interface, an example process flow is illustrated via the flow chart 80 of FIG. 6 with reference to the architectures of FIGS. 1-3 and the display elements of FIGS. 4 and 5. The illustrated process describes steps taken at the remote control center 2 and remote machines 3, 4, 5, 6. It will be appreciated that certain steps may be executed at the remote control center or at one or more of the machines 3, 4, 5, 6, and in some instances a location for such steps will be identified. This is not meant to imply that other steps may not also be executed at one or more machines instead, depending upon implementation preferences, or that a step described as occurring at a machine 3, 4, 5, 6 cannot instead take place at the remote control center 2.

Status information may be maintained at the relevant machine 3, 4, 5, 6, at the remote control center 2, redundantly at both locations, or piecemeal across both locations. Moreover, it will be appreciated that operations taking place at the remote control center 2 may be executed via the computing device 31, and operations taking place at one or more machines 3, 4, 5, 6 may be executed via the controller 11 associated with each such machine. Similarly, alerts may be generated at the remote control center 2 based on received data or may be generated at the machines 3, 4, 5, 6 and transmitted to the remote control center 2. While the illustrative example of FIG. 6 shows the former, either implementation may be used depending upon builder preference.

The process begins at stage 81, wherein each machine 3, 4, 5, 6 gathers data to be sent to the remote control center 2. In an embodiment, the gathered data includes sensor data, video data, and alert data. The sensor data may include any sensor output or data derived there from including, for example, GPS data, hydraulic and lubricating fluid temperature and level data, machine tilt and roll data, fuel or charge level data, and so on.

The collected video data may include primarily video image data from the onboard video camera of the associated machine, but may also include other data such as but not limited to audio data. The alert data may include information defining an alert or information based upon which an alert may be warranted. For example, if the machine has encountered an immovable obstruction such as a large stone or a rock formation, the alert data may comprise a request for operator interaction or may simply comprise an indication that an immovable obstruction is present.

At stage 82, each machine 3, 4, 5, 6 bundles the associated sensor data, video data, and alert data for wireless transmission, e.g., by packetizing, quantizing, compressing and/or otherwise processing the material so that it may be sent wirelessly to the remote control center 2. At stage 83, the bundled material is transmitted from each machine 3, 4, 5, 6 to the remote control center 2.

Upon receipt of the transmitted material at stage 84, the remote control center 2 processes the received material at stage 85 to yield a video stream associated with each machine 3, 4, 5, 6 and displays each video stream separately. At stage 86, the remote control center 2 parses the sensor data and alert data for each machine 3, 4, 5, 6 to produce a wireless link status, machine health status, and operating mode status for each machine 3, 4, 5, 6. The remote control center 2 then populates each machine area 56, 57, 58, 59 in the machine mode and alert indicator 55 display element at stage 87 so as to convey the wireless link status, machine health status, and operating mode status for each machine 3, 4, 5, 6.

At stage 88, the remote control center 2 receives operator input, e.g., via the display screen 32, keyboard input device 33 or one or more peripheral user interface devices such as the joystick 34 or other input device. The received user input may comprise a machine, control input, a machine mode change, or an operator alert selection with respect to a health level indicator, e.g., one of the first health level indicator 62, the second health level indicator 63 and the third health level indicator 64.

The remote control center 2 then executes an indicated task based on the received operator input. For example, if the received operator input includes a machine control input, then the remote control center 2 transmits a corresponding machine control command to the machine associated with the control input at stage 89.

Similarly, if the received operator input includes a machine mode change, the remote control center 2 may locally change a mode identified with the machine and also notify the relevant machine of the new mode at stage 90. For example, if the machine is to be converted from the autonomous mode to the remote control mode, the remote control center 2 may instruct the machine to cease autonomous control and instead accept and act upon operator commands.

Finally, if the received operator input includes an operator alert selection with respect to a health level indicator of one of the machines 3, 4, 5, 6, then the operator control center may display more detailed machine data associated with the selection at stage 91. For example, the remote control center 2 may display a textual description of the alert condition to the operator.

It will be appreciated that the present disclosure provides a system and method for facilitating remote operator visualization and control of the operating mode of a machine. While only certain embodiments have been set forth, alternatives and modifications will be apparent from the above description to those skilled in the art. These and other alternatives are considered equivalents and within the spirit and scope of this disclosure and the appended claims.

What is claimed is:

1. A method for displaying machine mode information to an operator at a remote control center with respect to a plurality of machines, the method comprising:
collecting video data from each of the plurality of machines, the video data for each machine showing at least a portion of an environment of the machine;
collecting machine sensor information from each of the plurality of machines;
generating machine alert information with respect to each of the plurality of machines;
collecting machine operating mode data indicative of an operating mode with respect to each of the plurality of machines; and
providing a machine display at the remote control center, the machine display including one or more screen regions, each of the one or more screen region displaying video data collected from an associated one of the plurality of machines, the machine display further including a machine mode and alert indicator including a plurality of machine areas, each machine area being associated with one of the plurality of machines, and each machine area including a graphical mode indicator visually denoting the operating mode of the associated machine.

2. The method for displaying machine mode information to an operator at a remote control center according to claim 1, wherein the one or more screen regions display video data collected from a single one of the plurality of machines, and wherein the operator is able to toggle the one or more screen regions to display video from any one of the plurality of machines.

3. The method for displaying machine mode information to an operator at a remote control center according to claim 1, wherein the operating modes include one or more of an autonomous mode wherein the machine operates autonomously, a remote control mode wherein the machine operates by remote control, an autonomous paused mode wherein the machine is paused and its most recent operating mode was the autonomous mode, and a remote control paused mode wherein the machine is paused and its most recent operating mode was the remote control mode.

4. The method for displaying machine mode information to an operator at a remote control center according to claim 1, wherein at least one graphical mode indicator is selectable to alter the operating mode of the associated machine.

5. The method for displaying machine mode information to an operator at a remote control center according to claim 1, wherein at least a subset of the machine areas further contain a graphical health level indicator identifying a health level of the associated machine.

6. The method for displaying machine mode information to an operator at a remote control center according to claim 5, wherein the appearance of each health level indicator is determined based on the health level of the associated machine.

7. The method for displaying machine mode information to an operator at a remote control center according to claim 6, wherein each health level indicator is rendered in a color and wherein the color is determined based on the health level of the associated machine.

8. The method for displaying machine mode information to an operator at a remote control center according to claim 6, wherein at least one of the health level indicators is dynamically varied based on the health level of the associated machine.

9. The method for displaying machine mode information to an operator at a remote control center according to claim 5, wherein at least one of the health level indicators is associated with the emission of an operator-audible tone.

10. The method for displaying machine mode information to an operator at a remote control center according to claim 1, wherein each machine area further includes a graphical wireless link indicator visually indicative of a status of a wireless link between the associated machine and the remote control center.

11. A method for displaying machine mode information to an operator at a remote control station for a plurality of machines, the method comprising:
displaying video data gathered from at least one of the plurality of machines to the operator via a video display screen, the video data showing at least a portion of an environment of the associated machine; and
displaying a machine mode and alert indicator to the remote operator, the machine mode and alert indicator including a plurality of machine areas, each machine area being associated with one of the plurality of machines, and each machine area including a graphical mode indicator visually denoting an operating mode of the associated machine.

12. The method for displaying machine mode information to an operator at a remote control station according to claim 11, wherein the operating modes include one or more of an autonomous mode wherein the machine operates autonomously, a remote control mode wherein the machine operates by remote control, an autonomous paused mode wherein the machine is paused and its most recent operating mode was the autonomous mode, and a remote control paused mode wherein the machine is paused and its most recent operating mode was the remote control mode.

13. The method for displaying machine mode information to an operator at a remote control station according to claim 11, wherein at least one of the graphical mode indicators is selectable to alter the operating mode of the associated machine.

14. The method for displaying machine mode information to an operator at a remote control station according to claim 11, wherein at least a subset of the machine areas further contain a graphical health level indicator identifying a health level of the associated machine.

15. The method for displaying machine mode information to an operator at a remote control station according to claim 14, wherein the appearance of each health level indicator is determined based on the health level of the associated machine.

16. The method for displaying machine mode information to an operator at a remote control station according to claim 15, wherein at least one of the health level indicators is associated with the emission of an operator-audible tone.

17. The method for displaying machine mode information to an operator at a remote control station according to claim 11, wherein each machine area further includes a graphical wireless link indicator visually indicative of a status of a wireless link between the associated machine and the remote control center.

18. The method for displaying machine mode information to an operator at a remote control station according to claim 11, wherein displayed video data includes, at any time, only video data collected from a single one of the plurality of machines, and wherein displaying video data gathered from at least one of the plurality of machines further comprises presenting to the operator an option to toggle the displayed video data to correspond to video from an alternative one of the plurality of machines.

19. A system for displaying an operating mode for each of a plurality of machines to an operator situated at a remote control center that is located remotely from the plurality of machines, the system comprising:
a wireless link at the remote control center configured to wirelessly gather data from each of the plurality of machines; and
a processor at the remote control center configured to generate the operating mode for each of the plurality of machines based on the gathered data and to generate a display comprising a machine mode and alert indicator having a plurality of adjacent machine areas, each machine area being associated with one of the plurality of machines, and each machine area including a graphical mode indicator visually denoting the operating mode of the associated machine.

20. The system for displaying an operating mode associated with each of a plurality of machines according to claim 18, wherein each operating mode is selected from the group consisting of an autonomous mode wherein the machine operates autonomously, a remote control mode wherein the machine operates by remote control, an autonomous paused mode wherein the machine is paused and its most recent operating mode was the autonomous mode, and a remote control paused mode wherein the machine is paused and its most recent operating mode was the remote control mode.
